(19) United States
(12) Patent Application Publication
(10) Pub. No.: US 2023/0314147 A1
(43) Pub. Date: Oct. 5, 2023

(54) PATH GENERATION APPARATUS, PATH PLANNING APPARATUS, PATH GENERATION METHOD, PATH PLANNING METHOD, AND NON-TRANSITORY COMPUTER READABLE MEDIUM

(71) Applicant: NEC Corporation, Minato-ku, Tokyo (JP)

(72) Inventors: Aayush AGGARWAL, Tokyo (JP); Ryota HIGA, Tokyo (JP); HIroaki INOTSUME, Tokyo (JP)

(73) Assignee: NEC Corporation, Minato-ku, Tokyo (JP)

(21) Appl. No.: 18/021,532

(22) PCT Filed: Sep. 29, 2020
(86) PCT No.: PCT/JP2020/036856

§ 371 Date: Feb. 15, 2023

(51) Int. Cl. G01C 21/34

(52) U.S. Cl. CPC G01C 21/3446

(57) ABSTRACT

An object of the present disclosure is to provide a path generation method that can generate a set of paths from any start nodes to any goal nodes with the distribution given by the user. A path generator (06) includes a path finder (13) generates a plurality paths based on a plurality of weights between nodes, the nodes being included in a map, a weight generator (12) generates the plurality of weights defined between the nodes based on a predetermined distribution.

### TECHNICAL FIELD

The present invention relates to a path generation method, path generation system between a start node to goal node in road network.

### BACKGROUND ART

Path planning refers to a task of finding a continuous path from a given start node to a given goal node. Path planning is required for robots, automated guided vehicles (AGVs), unmanned aerial vehicles (UAVs), and vehicles for route finding. For planning a path, a road map in the case of a vehicle or an area/floor map in the case of robots as shown in FIG. 1 is converted into a graph as shown in FIG. 2. Given a start node and a goal node, there are multiple paths that can be generated as shown in FIG. 2. For example, from the start node to the goal node, there are some paths such as path [S, a, b, c, G] or path [S, d, e, f, g, G]. Among all the paths which are available, different users may prefer different paths depending on whether they want to minimize the total length of a path, travel time of a path, risk associated with a path etc. Thus, different paths may have different utility values for different users. Here, the utility value is the preference/importance of the path for a specific user. Every user wants to find the path having the maximum utility value.

In many cases, the utility value of the paths is defined based on multiple criteria. In those cases, it becomes difficult to predict the utility value of a new path. For example, a user may define the utility of the paths based on the time it takes to travel on the paths. Travel time depends on various factors e.g. length of the road, speed limit on the road, traffic on the road etc. To make a more accurate prediction of the path utility, Machine Learning (ML) models are used. In a case where data is unavailable, synthetic data is generated for training ML models. In the case of path planning, the data refers to a set of valid paths from the given start node to the given goal node in a network. One of the assumptions of the ML models is that the training data and the test data may come from one data distribution. Another one of the assumptions is that the training data and the test data may come from various data distributions as shown in FIG. 3 since different users have different path preferences. FIG. 3 shows that 3 users, which are u1, u2, and u3, each have their own respective path preference indicated by D1, D2, D3. Thus, different users need different training data distributions.

To generate the training data which is a set of paths from the given start node to the goal node, several methods have been proposed in literature. A prior method for generating multiple paths from the given start node to the given goal node is self-avoiding random walk (SAW) [NPL 1]. In SAW, paths are generated by randomly picking nodes from start nodes to goal nodes. Another method for path generation is described in EP0547548B1 [PTL 1]. In PTL 1, paths can be generated by using an optimal path finding algorithm like “Dijkstra” where an optimal path is the path that is the least costly either in terms of total length or travel time or some other roadway parameters like road tax etc. Once the optimal path is generated, the next path can be generated by increasing the cost (weight of edge values of line segments) of the optimal path in the digital graph. PTL 2 discloses the shortest route from the start node to the goal node by using the weighting value.

### CITATION LIST

### Patent Literature

PTL 1: EP0547548A1
PTL 2: JP2013-148390 A

### Non Patent Literature

NPL 1: ALAN D. SOKAL, 17 May 1994, MONTE CARLO METHODS FOR THE SELF-AVOIDING WALK

### SUMMARY OF INVENTION

### Technical Problem

Training data is required to train the AI models. In some cases, however, the training data is unavailable/costly. In those cases, synthetic data generation is required. In the field of path planning, the training data consists of valid paths from the given start node to the goal node. Also, for different users, the preferences regarding data are different. For example, a surveillance robot requires a set of long paths while a taxi service requires a set of short paths. So the synthetic data generation method should generate paths in accordance with the user's desired data distributions.

The NPL1 method generates a path randomly, so the path distribution of the generated path cannot be controlled. Thus, since different users have different preferences, SAW will not be able to generate the training data as per their requirements. A problem with the method disclosed in PTL 1 and PTL 2 is that it will generate training data biased towards less costly paths. Neither of the above methods allows users to define the desired path distribution to be generated from the path generation method. An object of the present disclosure is to provide a path generation method/system that can generate a set of paths from any start nodes to any goal nodes with the path distribution given by the user.

### Solution to Problem

A path generation apparatus according to a first aspect of the present disclosure includes: path finding means for generating a plurality paths based on a plurality of weights between nodes, the nodes being included in a map, weight generation means for generating the plurality of weights defined between the nodes based on a predetermined distribution.

A path planning apparatus according to a second aspect of the present disclosure includes: path generation means for generating a plurality paths based on a plurality of weights between nodes, the nodes being included in a map, and generating the plurality of weights defined between the nodes based on a predetermined distribution, learning means for using the plurality paths as training data and training the machine learning models based on the training data, and prediction means for calculating a predicted value by using the trained models.

A path generation method according to a third aspect of the present disclosure includes: generating a plurality of weights defined between nodes based on a predetermined distribution; and generating a plurality paths based on the plurality of weights between the nodes, the nodes being included in a map.

A path planning method according to a fourth aspect of the present disclosure includes:
generating a plurality of weights defined between nodes based on a predetermined distribution; generating a plurality paths based on the plurality of weights between the nodes, the nodes being included in a map; using the plurality paths as training data; training the machine learning models based on the training data; and calculating a predicted value by using the trained models.

A non-transitory computer readable medium storing a program according to a fifth aspect of the present disclosure causes a computer to: generate a plurality of weights defined between nodes based on a predetermined distribution; and generate a plurality paths based on the plurality of weights between the nodes, the nodes being included in a map.

A non-transitory computer readable medium storing a program according to a sixth aspect of the present disclosure causes a computer to: generate a plurality of weights defined between nodes based on a predetermined distribution; and generate a plurality paths based on the plurality of weights between the nodes, the nodes being included in a map; use the plurality paths as training data; train the machine learning models based on the training data; and calculate a predicted value by using the trained models.

### Advantageous Effects of Invention

According to the present invention, the path distribution for generating a set of paths can be controlled as per the user application. This leads to better training of AI models and thus enables better prediction accuracy.

### BRIEF DESCRIPTION OF DRAWINGS

FIG. 1 shows a road map or an area/floor map.

FIG. 2 shows a graph generated based on the road map or the area/floor map.

FIG. 3 shows a training data distribution.

FIG. 4 is configuration diagram of a path planning apparatus according to a first example embodiment.

FIG. 5 shows a basic architecture of the ML models.

FIG. 6 shows a basic architecture of the ML models according to a first example embodiment.

FIG. 7 is configuration diagram of a path generator according to a first example embodiment.

FIG. 8 shows a road network represented by graph G with weights W according to a first example embodiment.

FIG. 9 shows a road network represented by graph G with weights W according to a first example embodiment.

FIG. 10 shows the weight generation method 1 according to a first example embodiment.

FIG. 11 shows the weight generation method 2 according to a first example embodiment.

FIG. 12 is a flow of a path generation process according to a first example embodiment.

FIG. 13 is a configuration diagram of a path planning apparatus according to each example embodiment.

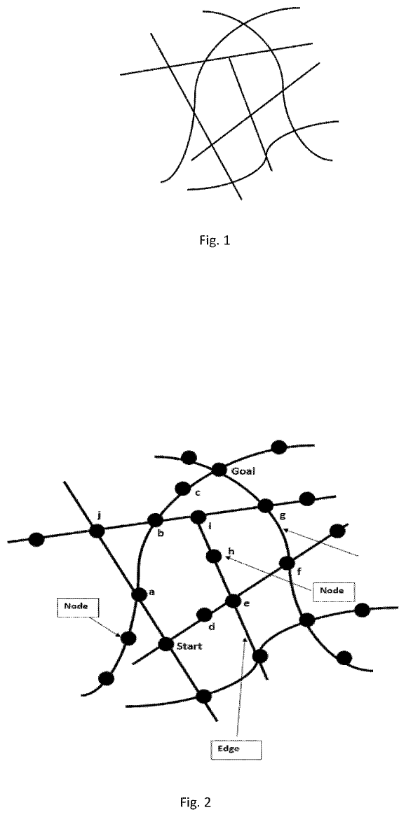

### DESCRIPTION OF EMBODIMENTS

### First Embodiment

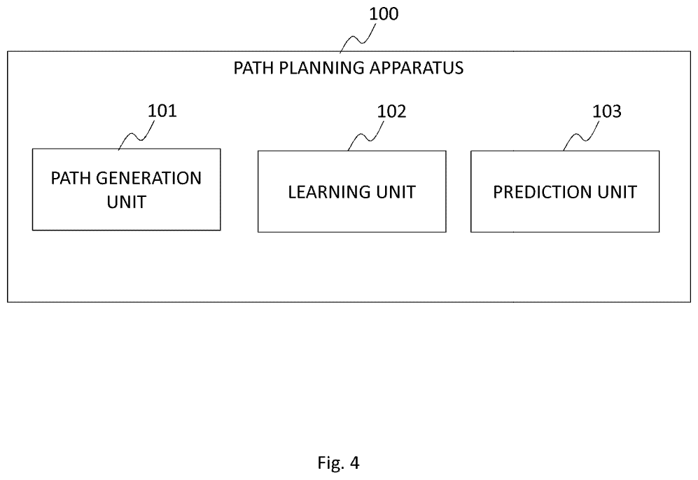

Embodiments of the present disclosure are described hereinafter with reference to the drawings. A configuration example of a path planning apparatus 100 according to a first embodiment of the present disclosure is described with reference to FIG. 4. The path planning apparatus 100 includes a path generation unit 101, a learning unit 102 and a prediction unit 103.

The path planning apparatus 100 may be a computer apparatus that operates as a processor executes a program stored in a memory. The path generation unit 101, the learning unit 102 and the prediction unit 103 may be software or modules by which processes are performed as a processor executes a program stored in a memory. Alternatively, the path generation unit 101, the learning unit 102 and the prediction unit 103 may be hardware such as a circuit or a chip.

The path generation unit 101 generates a set of paths for a given user's desired path distribution. The learning unit 102 uses the generated path as training data and trains the machine learning models based on the training data. The prediction unit 103 takes the trained models and predicts a value. Consider an example where multiple users want to go from a start point or a start node to a goal point or a goal node in the network shown in FIG. 2. Since there are multiple paths, different users may want to find out expected travel times for different paths. The travel time may depend on various factors, e.g. travel length, speed limit, and traffic on each path.

Different users may be interested in different path profiles as per their requirements. The path profiles indicate the path utilities. User A may want to know the travel time of only short length paths while user B may be interested in both short length paths and some relatively longer length paths. Thus, a path generation algorithm, which generates multiple sets of paths with path length distributions as per the user's application, is required. For example, the path generation method should generate a set of paths for user A and another set of paths for user B. This set of paths can be used as the synthetic data for the training ML models as well candidate paths for which the users may want to predict the travel time. To make a more accurate prediction of path utility, the Machine learning (ML) models are used.

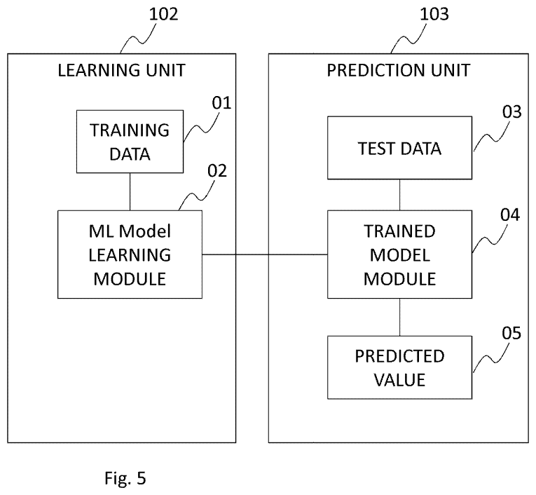

The basic architecture of the ML models is shown in FIG. 5. The learning unit 102 includes training data 01 and a ML model learning module 02. The training data 01 is fed into the ML model learning module 02 to train the ML model denoted by a function “f”. The training data 01 is represented by (Xₜᵣₐᵢₙ, Yₜᵣₐᵢₙ) where x (the element x is a member of the set Xₜᵣₐᵢₙ) is a sample and y (the element y is a member of the set Yₜᵣₐᵢₙ) is f(x). As a result, the trained model f_{trained} is stored in a trained model module 04 of the prediction unit 103. When the test data 03, which is represented by xₜₑₛₜ, in the prediction unit 103 is fed into the trained model module 04, a predicted value 05, which is f_{trained}(xₜₑₛₜ), is calculated by the trained model module 04.

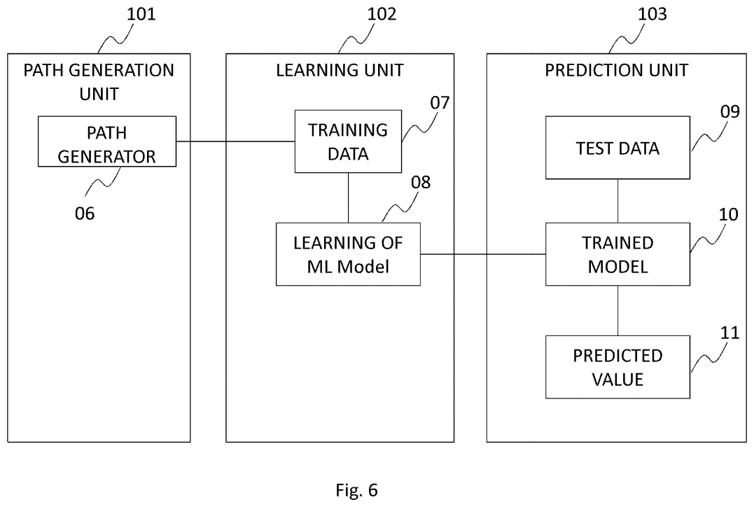

In path planning, x (the element x is a member of the set X) is the candidate path, and X is a set of valid paths from the start point to the goal point and y is the utility value of the candidate path. Since x needs to be a valid path, the training data 07 should be generated from the path generation algorithm in a case where data is unavailable as shown in FIG. 6. The blocks 07, 08, 09, 10, 11 in FIG. 6 respectively correspond to blocks 01, 02, 03, 04, 05 in FIG. 5. Only block 06 which generates synthetic training data is added as a path generator 06 of the learning unit 101 in FIG. 6.

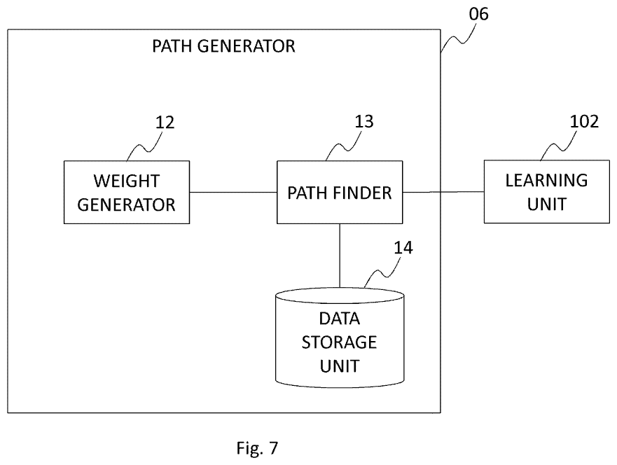

The detailed configuration of the path generator 06 is explained in FIG. 7. FIG. 7 shows the path generator 06 as a path generator module. The path generator 06 includes a weight generator 12, a path finder 13 and a data storage unit 14.

The weight generator 12, the path finder 13 and the data storage unit 14 may be software or modules by which processes are performed as a processor executes a program stored in a memory. Alternatively, the weight generator 12, the path finder 13 and the data storage unit 14 may be hardware such as a circuit or a chip.

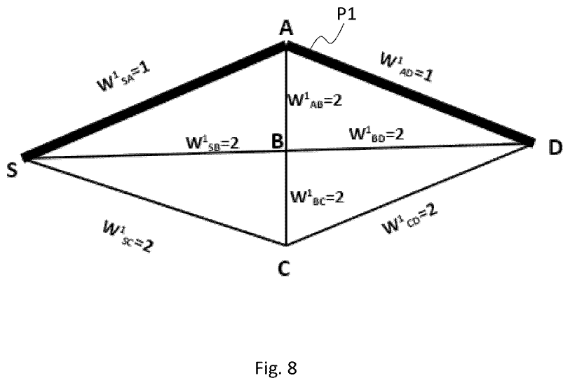

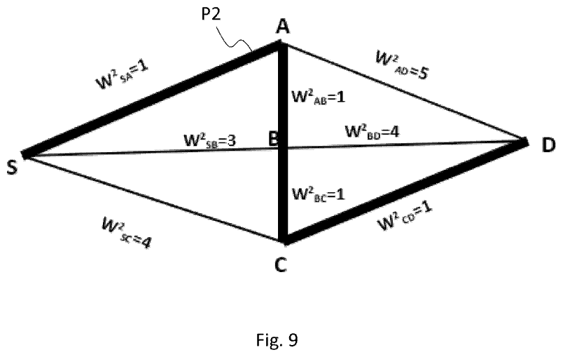

The operation and function of the path generator 06 are explained as follows. To generate paths, a road network may be considered to be unidirectional, bidirectional or mixed graph while the road intersection may be considered to be the nodes of the graph. The weights Wᵤᵥ (u,v) (the element Wᵤᵥ (u,v) is a member of the set W) represents the distance between two intersections u and v in the road network. Thus, the road network can be represented by graph G with weights W as shown in FIGS. 8 and 9.

To find the shortest path between two nodes S and D, any shortest path finding algorithm may be used. A* algorithm and Dijktras' algorithm are well known algorithms used to compute the shortest path for an origin-destination pair in a given graph G and weights W.

The path finder 13 finds the shortest path by using a given graph G and weights W. The path finder 13 may use any of the shortest path finding algorithms as explained above. Since our objective is to generate multiple different paths in a given origin-destination pair and not just to generate the shortest path, the weight generator 12 changes the weights in the graph G every time a path is generated.

As shown in FIG. 8 when weight W¹ is used in the graph G with the origin destination pair S-D, the shortest path finding algorithm generates path P1. When the weight generator 12 changes the weight from W¹ to W² as shown in FIG. 9, the shortest path finding algorithm generates path P2. Thus, multiple paths can be generated in the given origin destination pair by varying the weights of the graph G and using any of the shortest path finding algorithms.

If the weight W in the graph G represents distance between adjacent nodes, then the true weight W^{o} _{u,v} represents the actual distance between nodes u and v. Similarly, if the weights represent the travel time between nodes u and v, then the true weight W^{o}_{u,v} represents the average travel time between nodes u and v. To generate multiple paths (e.g. N paths, N is integer), multiple pseudo weights (W¹, W² . . . W^{N}) are generated by the weight generator 12.

When a pseudo weight Wⁱ is fed into the path finder 13, the path finder 13 generates a path Pⁱ. So, when N pseudo weights are fed into the path finder 13, N different paths are generated.

One of the ideas of the disclosure is to generate multiple paths for the given origin destination pair in such a way that the path distribution is controlled by the user. As a result, instead of generating the pseudo weights of the graph G arbitrarily, the pseudo weights may be generated based on the user's preference regarding the path distribution.

The generated paths are finally stored in the data storage unit 14 and sent to the learning unit 102. The function of the weight generator 12 is explained in detail below.

The Weights generator 12 generates pseudo weights for the graph G. The weight generator 12 generates N pseudo weights by using W° and the path distribution desired by the user. N shows the number of generated pseudo weights. W° shows the true weight of the graph G. The pseudo weights are generated as follows.

Original/true weight is W^{o} and W^{o}_{i,j} is the true weight between adjacent nodes i and j. To generate a pseudo weight W^{k}, the weight W^{k}_{i,j} is assumed to follow Gaussian distribution N as is defined as follows.

W^{k}_{i,j}˜N (M=W⁰_{i,j}, Sigma) where the element k is a member of the set [1, 2, . . . N]

The values M and Sigma are mean and standard deviation of the Gaussian distribution N. Here M is the true weight while Sigma is the parameter that depends on the user's desired path length distribution. The parameter Sigma brings randomness to pseudo weights. If Sigma is 0, then the generated pseudo weight W^{k} is the same as the true weight W^{o}. When Sigma is not 0, the generated pseudo weight W^{k} is different from W⁰ and thus when a plurality of the generated pseudo weights are fed into the path finder 13, the path finder 13 generates a plurality of paths.

The effect of standard deviation Sigma on the path generation is as follows. When the Sigama >0 but the S is close to 0, for example, the S is 0.5 or 1, then the deviation in the pseudo weight W^{k}_{i,j} from the true weight W^{o}_{i,j} is small and thus the pseudo weight W^{k} and the true weight W^{o} are highly similar to each other. That is, the deviation in the pseudo weight W^{k}_{i,j} is close to the deviation in the true weight W^{o}. When a path is generated by using W^{k}, the generated path has a path utility value close to that of the shortest path value generated by using the true weight W^{o}. As the value of Sigma increases, the deviation in the pseudo weight W^{k}_{i,j} increases and thus a path having value in terms of path length or travel time or the cost depending upon the definition of true weights W^{o} increases and thus the probability of generating a longer length path increases.

The value of Sigma may be set by the user. The user can use this value to generate a set of paths based on the path distribution desired by the user. There are two ways by which user can define the value of Sigma.
(1) Method 1: To generate the set of paths with the desired distribution, the pseudo weights can be generated by setting Sigma=C, where the user defines C as C=Constant and C>0.

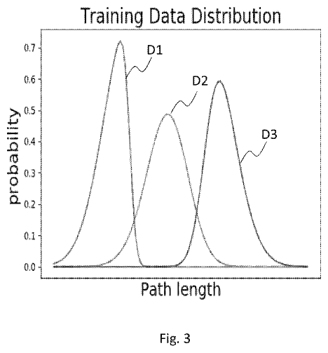

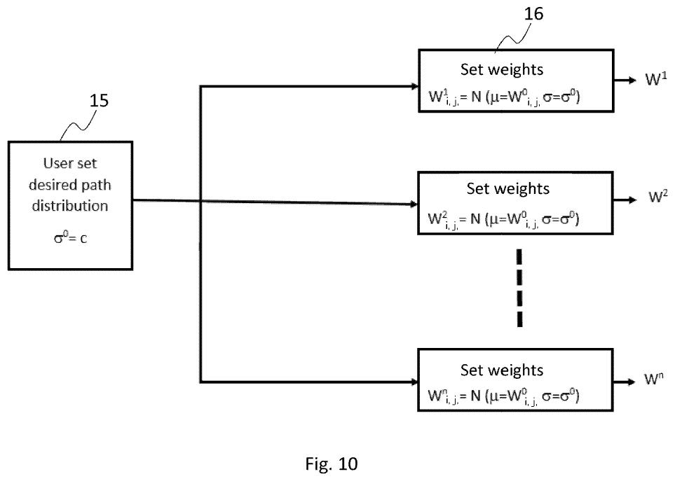

By changing the value of C, different paths with different distributions can be generated. If the value of C is close to 0, then paths are generated with a distribution like D1 shown in FIG. 3. On the other hand, if the value of C is large, then paths are generated with distributions like D2 and D3 shown in FIG. 3. FIG. 10 shows the weight generation method 1. To generate a set of paths, the user sets the value of Sigma by defining C, for example Sigma⁰=C, based on the user's desired distribution as shown in step 15 in FIG. 10. Then to generate each path, the pseudo weight W^{k} is generated by setting W^{k}_{i,j} using a normal distribution with M=W⁰_{i,j} and Sigma=Sigma⁰ as shown in step 16 in FIG. 10. Since the normal distribution is a probability distribution, each time a new value of W^{k}_{i,j} is generated, W¹ and W^{m} are generated as follows: for any 1 (small L), m, W¹≠W^{m} for m≠1. When a pseudo weight Wⁱ is fed into the path finder 13, the path finder 13 generates a path Pⁱ and stores the path Pⁱ in the data storage unit 14.
(2) Method 2: Another way of setting Sigma is to assume that Sigma follows the distribution D which reflects the user's desired distribution. Since Sigma cannot be negative, the distribution D should be chosen such that the distribution D generates positive values only. One such distribution is Gamma Distribution. If the gamma distribution is used for defining Sigma, then the user has to set two parameters, such as a shape parameter and a rate parameter.

The gamma distribution is shown as follows: Sigma˜T(A, B)

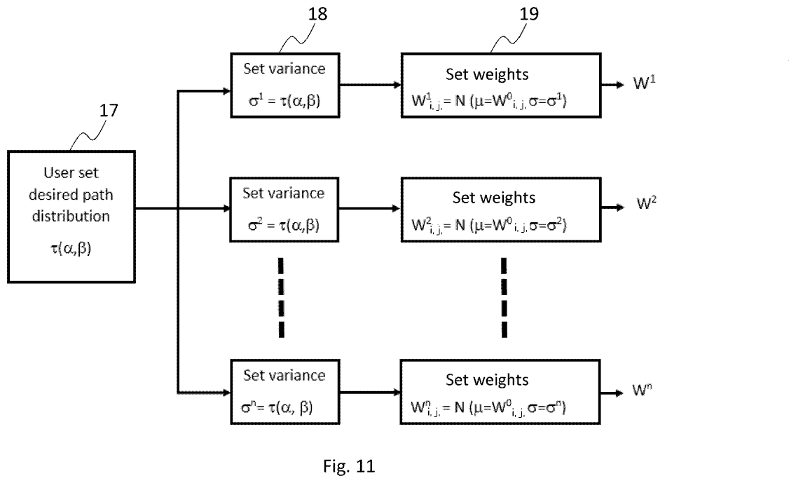

For example, A is the shape parameter while B is the rate parameter. The mean and the standard deviation of the gamma distribution are defined as A/B and A/B² respectively. So, if Sigma has a small value, B>>A and A and B should be set for the desired mean and standard deviation of the Sigma in order to get various distributions. The FIG. 11 shows the weight generation method 2.

To generate a set of paths, first of all, the user has to define the desired distribution by defining the parameters of the gamma distribution A and B as shown in step 17. Then to generate each path, the value of Sigma is sampled from the gamma distribution in step 18. Since the gamma distribution is a probability distribution, different values of Sigma are generated each time even if the values of A and B are fixed. For example, Sigma indicates Sigma¹, Sigma², and Sigmaⁿ. The pseudo weight W^{k} is generated by setting W^{k}_{i,j} using a normal distribution with M=W⁰_{i,j} and S=Sigma^{k} as shown in block 19, and then the pseudo weight is fed into the path finder 13 which then generates a path and stores the path in the data storage unit 14.

In the method 1, the value of S is fixed for generating all the weight sets and the variation in the paths is due to the randomness in W^{k}. In the method 2, the value of S varies each time a weight W^{k} is generated. Thus, the variation in the paths is due to randomness in W^{k} as well as Sigma. Since the second method can control the variation of Sigma, this method gives more freedom to the user to define his/her distribution preference. Both methods can be used to generate pseudo weights.

Next, the path finder 13 is explained. Given the network, the origin destination pair and a set of pseudo weights W^{k} where the element k is a member of the set [1, 2, . . . , N], the path finder 13 generates N paths by using a shortest path finding algorithm. One of these paths is generated for each weight W^{k}. Any shortest path finding algorithm like A* algorithm or Dijkstra's algorithm can be used to generate paths.

Next, the data storage unit 14 is explained. Once the paths are generated, they need to be stored in the data storage unit 14. Further, the data set can be divided into training and test sets if it is to be used for training AI models.

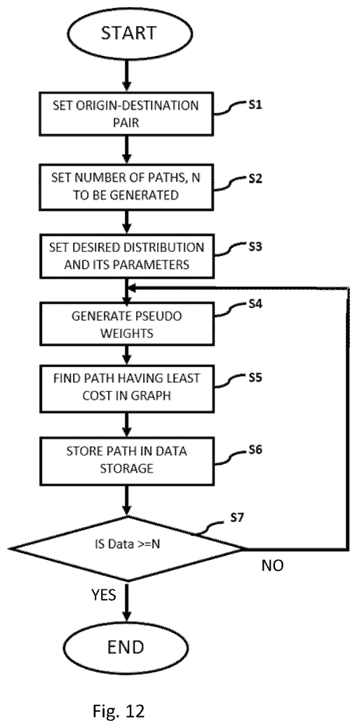

Next, a flow of a path generation process according to the first embodiment of the present disclosure is described with reference to FIG. 12. FIG. 12 is a flow chart of the user defined path generation method. First, the weight generator 12 receives the start node and the goal node from the user (S1).

Next, the weight generator 12 receives the value N that is the number of paths to be generated from the user (S2). Next, the weight generator 12 receives the parameters related to the user's desired path distribution by either method 1 or 2 (S3). The weight generator 12 generates the pseudo weights by using the method 1 or 2 (S4).

Next, the path finder 13 finds the path the cost of which is the least one in the generated cost matrix from the given start point to the given goal point by using any shortest path finding algorithm (S5). Next, the path finder 13 stores the generated path in the data storage unit 14 (S6). If the number of paths in the data storage unit 14 is less than the value N, then the weight generator 12 generates the pseudo weights in step S4 (S7). If the number of paths in the data storage unit 14 is equal to or more than the value N, the processing in FIG. 12 is completed.

As described above, the path planning apparatus can generate a plurality of paths by using a plurality of weights.

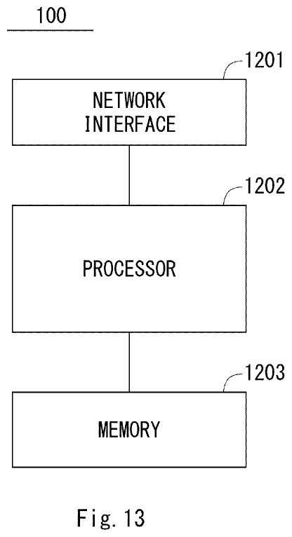

FIG. 13 is a block diagram showing an example of the configuration of the path planning apparatus 100 described in the above-described example embodiments. Referring to FIG. 13, the path planning apparatus 100 includes a network interface 1201, a processor 1202, and a memory 1203. The network interface 1201 is used for communication with other network node apparatuses constituting the communication system. The network interface 1201 may include, for example, a network interface card (NIC) in conformity with IEEE 802.3 series.

The processor 1202 may load software (a computer program) from the memory 1203 and execute the loaded software, thereby performing the processes of the path planning apparatus 100 described by using the sequence diagram and the flowchart in the above-described embodiments. The processor 1202 may be, for example, a microprocessor, an MPU (Micro Processing Unit), or a CPU (Central Processing Unit). The processor 1202 may include a plurality of processors.

The memory 1203 is formed by a combination of a volatile memory and a nonvolatile memory. The memory 1203 may include a storage located remotely from the processor 1202. In this case, the processor 1202 may access the memory 1203 through an I/O interface (not shown).

In the example shown in FIG. 13, the memory 1203 is used to store a group of software modules. The processor 1202 may load the group of software modules from the memory 1203 and execute the loaded software module, thereby performing the processes of the path planning apparatus 100 described in the above-described embodiments.

As described above with reference to FIG. 13, each of the processors included in the path planning apparatus 100 executes one or a plurality of programs including a group of instructions for causing a computer to perform the algorithm described above with reference to the drawings.

In the above-described examples, the program may be stored in various types of non-transitory computer readable media and thereby supplied to the computer. The non-transitory computer readable media includes various types of tangible storage media. Examples of the non-transitory computer readable media include a magnetic recording medium (such as a flexible disk, a magnetic tape, and a hard disk drive) and a magneto-optic recording medium (such as a magneto-optic disk). Further, examples of the non-transitory computer readable media include CD-ROM (Read Only Memory), CD-R, and CD-R/W. Further, examples of the non-transitory computer readable media include a semiconductor memory. The semiconductor memory includes, for example, a mask ROM, a PROM (Programmable ROM), an EPROM (Erasable PROM), a flash ROM, and a RAM (Random Access Memory). These programs may be supplied to the computer by using various types of transitory computer readable media. Examples of the transitory computer readable media include an electrical signal, an optical signal, and an electromagnetic wave. The transitory computer readable media can be used to supply programs to the computer through a wired communication line (e.g., electric wires and optical fibers) or a wireless communication line.

Further, the present disclosure is not limited to the above-described embodiments and can be modified as appropriate without departing from the scope and spirit of the disclosure. Further, the present disclosure may be implemented by combining those example embodiments as appropriate.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

Further, the whole or part of the embodiments disclosed above can be described as, but not limited to, the following supplementary notes.

### Supplementary Note 1

A path generation apparatus comprising:
path finding means for generating a plurality paths based on a plurality of weights between nodes, the nodes being included in a map,
weight generation means for generating the plurality of weights defined between the nodes based on a predetermined distribution.

### Supplementary Note 2

The path generation apparatus according to Supplementary note 1, wherein
the weight generation means is configured to receive user input parameters that set a path distribution desired by a user and generate the plurality of weights by using the path distribution.

### Supplementary Note 3

The path generation apparatus according to Supplementary note 2, wherein
the path distribution includes the values M that indicates mean of Gaussian distribution and Sigma that indicates standard deviation of the Gaussian distribution, and
the weight generation means is configured to generate the plurality of weights by using the path distribution having a fixed value as the Sigma.

### Supplementary Note 4

The path generation apparatus according to Supplementary note 2, wherein
the path distribution includes the values M that indicates mean of Gaussian distribution and Sigma that indicates standard deviation of the Gaussian distribution, and
the weight generation means is configured to generate the plurality of weights by using the path distribution having a varied value as the Sigma.

### Supplementary Note 5

The path generation apparatus according to Supplementary note 3 or 4, wherein
the weight generation means is configured to generate the plurality of weights by using the path distribution having a fixed value as the value M.

### Supplementary Note 6

The path generation apparatus according to Supplementary note 5, wherein the fixed value as the value M represents the actual distance between the nodes.

### Supplementary Note 7

A path planning apparatus comprising:
path generation means for generating a plurality paths based on a plurality of weights between nodes, the nodes being included in a map, and generating the plurality of weights defined between the nodes based on a predetermined distribution,
learning means for using the plurality paths as training data and training the machine learning models based on the training data, and
prediction means for calculating a predicted value by using the trained models.

### Supplementary Note 8

The path planning apparatus according to Supplementary note 7, wherein
the path generation means is configured to receive user input parameters that set a path distribution desired by a user and generate the plurality of weights by using the path distribution.

### Supplementary Note 9

A path generation method comprising:
generating a plurality of weights defined between nodes based on a predetermined distribution; and
generating a plurality of paths based on the plurality of weights between the nodes, the nodes being included in a map.

### Supplementary Note 10

A path planning method comprising:
generating a plurality of weights defined between nodes based on a predetermined distribution; and
generating a plurality of paths based on the plurality of weights between the nodes, the nodes being included in a map;
using the plurality of paths as training data;
training the machine learning models based on the training data; and
calculating a predicted value by using the trained models.

### Supplementary Note 11

A non-transitory computer readable medium storing a program for causing a computer to:
generate a plurality of weights defined between nodes based on a predetermined distribution; and
generate a plurality of paths based on the plurality of weights between the nodes, the nodes being included in a map.

### Supplementary Note 12

A non-transitory computer readable medium storing a program for causing a computer to:
generate a plurality of weights defined between nodes based on a predetermined distribution; and
generate a plurality of paths based on the plurality of weights between the nodes, the nodes being included in a map;
use the plurality of paths as training data;
train the machine learning models based on the training data; and
calculate a predicted value by using the trained models.

### REFERENCE SIGNS LIST

06 PATH GENERATOR
12 WEIGHT GENERATOR
13 PATH FINDER
14 DATA STORAGE UNIT
100 PATH PLANNING APPARATUS
101 PATH GENERATION UNIT
102 LEARNING UNIT
103 PREDICTION UNIT

What is claimed is:

1. A path generation apparatus comprising:
at least one memory storing instructions, and
at least one processor configured to execute the instructions to;
generate a plurality paths based on a plurality of weights between nodes, the nodes being included in a map,
generate the plurality of weights defined between the nodes based on a predetermined distribution.

2. The path generation apparatus according to claim 1, wherein the at least one processor is further configured to execute the instructions to receive user input parameters that set a path distribution desired by a user and generate the plurality of weights by using the path distribution.

3. The path generation apparatus according to claim 2, wherein
the path distribution includes mean and standard deviation of the Gaussian distribution, and
at least one processor is further configured to execute the instructions to generate the plurality of weights by using the path distribution with a fixed value as the standard deviation.

4. The path generation apparatus according to claim 2, wherein
the path distribution includes mean and standard deviation of the Gaussian distribution, and
the at least one processor is further configured to execute the instructions to generate the plurality of weights by using the path distribution with a varied value as the standard deviation.

5. The path generation apparatus according to claim 3, wherein the at least one processor is further configured to execute the instructions to generate the plurality of weights by using the path distribution with a fixed value as the mean.

6. The path generation apparatus according to claim 5, wherein the fixed value as the mean value represents the actual distance between the nodes.

7. A path planning apparatus comprising:
at least one memory storing instructions, and
at least one processor configured to execute the instructions to;
generate a plurality paths based on a plurality of weights between nodes, the nodes being included in a map, and generating the plurality of weights defined between the nodes based on a predetermined distribution,
use the plurality paths as training data and training the machine learning models based on the training data, and
calculate a predicted value by using the trained models.

8. The path planning apparatus according to claim 7, wherein the at least one processor is further configured to execute the instructions to receive user input parameters that set a path distribution desired by a user and generate the plurality of weights by using the path distribution.

9. A path generation method comprising:
generating a plurality of weights defined between nodes based on a predetermined distribution; and
generating a plurality of paths based on the plurality of weights between the nodes, the nodes being included in a map.

10-12. (canceled)
